(19) United States
(12) Patent Application Publication
(10) Pub. No.: US 2002/0103718 A1
(43) Pub. Date: Aug. 1, 2002

(54) Print order system, printing system, order terminal and recording medium

(76) Inventors: Terumi Matsuda, Kaisei-machi (JP); Kazuo Shiota, Kaisei-machi (JP); Tooru Kurokawa, Kaisei-machi (JP); Makoto Hara, Kaisei-machi (JP)

Correspondence Address: BIRCH, STEWART, KOLASCH & BIRCH, LLP, P.O. BOX 747, Falls Church, VA, 22040-0747, US

(21) Appl. No.: 10/058,280

(22) Filed: Jan. 30, 2002

(30) Foreign Application Priority Data
Jan. 30, 2001 (JP) 2001-021624
May 29, 2001 (JP) 2001-160321

(51) Int. Cl. G06F 17/60

(52) U.S. Cl. 705/26

(57) ABSTRACT

When an order for printing image data is placed via a network, time necessary for reception of prints can be shortened and a DPE store can attract a user. The DPE store provides to the user a CD-R having viewer software and access information for accessing an order reception server of the store. The access information is input to a user terminal upon installation of the viewer software by the user. For placing the order, the user terminal accesses the order reception server 21 by using the viewer software, and information such as a charge per print and the time of delivery is transferred to the user terminal. The user confirms the information and transfers order information and the image data sets to the order reception server. The DPE store generates the prints based on the information and the data.

### BACKGROUND OF THE INVENTION

1. Field of the Invention

The present invention relates to a print order system for ordering printing of image data via a network.

2. Description of the Related Art

There have been known digital photograph service systems for carrying out various kinds of digital photograph services such as storing photographs obtained by users in image servers or in CD-Rs after digitization thereof, printing images obtained by users with digital cameras, and receiving orders for additional prints. As one form of such digital photograph service systems, a network photograph service system for receiving a print order or the like via a network such as the Internet has also been proposed.

In such a network photograph service system, a user installs viewer software in his/her personal computer which acts as a user terminal so that the user can reproduce image data recorded in a CD-R or obtained by using a digital camera. When the user places a print order or the like, the user generates order information describing the content of the print order by using an ordering function built in to the viewer software. The user then transfers the order information and image data representing an image or images to be printed from the user terminal to an order reception server installed in an order reception center or the like via a network such as the Internet. The order reception server transfers the image data and the order information to a printer server in a laboratory or in a mini-laboratory in a DPE store. The printer server carries out printing of the image data based on the order information, and an additional print, a picture postcard, an album, and the like are generated as ordered.

The print or the prints (hereinafter referred to as the prints) generated in the above manner are delivered to an agency specified by the user at the time of ordering the prints. The user visits the agency and receives the prints after paying a charge. As the agency, an agency located close to a place of residence or employment is generally designated by the user as desired.

The order information herein referred to is information such as a processing number for specifying the content of service (generation of an ordinary print or a picture postcard), an image number for specifying a photograph (a number representing an image data file), a print size, a quantity of prints, quality of printing paper (such as glossy or non-glossy), thickness of the printing paper, the content of photographic processing, and trimming specification, for example. The order information may further include information regarding the name, address, zip code and phone number of the user, for example.

When the prints are ordered in the network photograph service system described above, the order information is transferred to the order reception server installed in the order reception center and then transferred to a laboratory in collaboration with the agency specified by the user. Thereafter, the prints are delivered to the agency after printing, and handed to the user. Therefore, the user has to wait long for reception of the prints.

Furthermore, the user needs to specify the agency for receiving the prints when the user orders the print. There are several methods for the user to designate the agency: (1) selecting the desired agency from a list of agencies displayed on the user terminal; (2) selecting area information such as a prefecture by using the user terminal and then selecting the desired agency from a list of agencies in the selected area; (3) displaying a store closest to the user on the user terminal as the agency based on the zip code; and (4) directly inputting a name of the agency from the user terminal, for example. In this manner, the user can freely select the agency for receiving the prints.

However, an operation for selecting the agency is troublesome for the user. Especially, in the case where the user has already decided which agency to use, selection of the agency according to the methods (1) to (4) described above is annoying for the user. Furthermore, if the agency is a DPE store, it is difficult for the DPE store to induce the user to designate the store as the agency according to the methods (1) to (4), although the DPE store wishes the user to do so. Moreover, even if the DPE store makes an effort to promote its business, such as distribution of advertisements, the effort may not lead to a preferable result, since the user may designate another DPE store as the agency when he/she decides the desired agency from the list of agencies displayed on the user terminal.

### SUMMARY OF THE INVENTION

The present invention has been conceived based on consideration of the above circumstances. An object of the present invention is therefore to shorten the time a user has to wait for reception of prints.

Another object of the present invention is to enable a DPE store to attract a user as a customer.

A print order system of the present invention comprises:

order reception servers enabling reception of order information regarding image data via a network and installed respectively in photograph processing agencies each having a photographic printer for printing the image data; and

an order terminal connected to the order reception servers via the network and used for generating the order information and for placing a print order regarding the image data by transferring the order information to a corresponding one of the order reception servers installed in a specific one of the photograph processing agencies after directly accessing the order reception server of the specific photograph processing agency.

The “photograph processing agencies” herein referred to include any agencies dealing with prints. For example, a DPE store which a user can visit and receive a print at can be included. Alternatively, a laboratory which is dedicated to printing without having a storefront and provides a print by delivery may also be included.

The “order reception server” is a server computer installed in each of the photograph processing agencies and connected to the photographic printer and to a controller for controlling the order reception server and the printer. The order reception server is always connected to the network.

The “order terminal” may be a personal computer connectable to the network and owned by the user for placing the print order. Alternatively, the order terminal may be a network terminal installed in any of the photograph processing agencies.

As the image data to be printed, any image data can be used. For example, the image data to be printed may be image data obtained by the user with a digital camera, or image data recorded in a CD-R after digitization of photographs obtained by the user. The image data are transferred to the order reception server together with the order information.

The “specific one of the photograph processing agencies” is a photograph processing agency from which the user wishes to place the print order. For example, the specific photograph processing agency refers to a photograph processing agency close to a place of residence or employment of the user, or a photograph processing agency providing a preferable service or charging less.

“Directly accessing the order reception server in the specific photograph processing agency” refers to directly accessing the order reception server of the specific photograph processing agency, not via an order reception center or the like.

The “print order” includes not only an order for a print of the image data generated by the photographic printer, but also an order for printing an image on a postcard, a calendar, a T-shirt, a mug cup, a jigsaw puzzle, and a clock face (hereinafter referred to as generation of picture postcards or the like), for example. In the case where the specific photograph processing agency does not have equipment for generation of picture postcards or the like, the order for generation of picture postcards or the like is placed at another photograph processing agency in collaboration with the photograph processing agency not having the equipment.

The prints generated according to the order information may be directly provided to the user at the specific photograph processing agency. Alternatively, the prints may be mailed or delivered from the specific photograph processing agency to the user.

In the print order system of the present invention, it is preferable for the order information to be generated and transferred by a program installed in the order terminal. The program causes a computer to execute the procedures of generating the order information and transferring the order information to the order reception server installed in the specific photograph processing agency.

This program is provided to the user by being recorded in a computer-readable recording medium such as a CD-R, an FD, or a DVD. The user can generate and transfer the order information with the order terminal and without special equipment therefor, by installing the program recorded in the recording medium to the order terminal.

It is preferable for the recording medium having the program recorded therein to further include therein access information for accessing the order reception server of the specific photograph processing agency. As the “access information”, the URL, IP address, phone number, zip code, and address of the order reception server of the specific agency can be used, for example. When the program is installed, the access information is preferably taken in by the program so that the order terminal can automatically access the order reception server of the specific agency based on the access information at the time of transferring the order information.

If the access information is the phone number, the zip code, or the address (hereinafter referred to as the phone number or the like) of the order reception server, the order reception server cannot be accessed directly based on the access information. In this case, a table relating the phone number or the like to the URL or the IP address of the order reception server is stored in a predetermined server so that the order terminal can access the predetermined server to obtain the URL or the IP address by referring to the table based on the phone number or the like. Alternatively, the table may be recorded in a recording medium and provided to the user in advance so that the order terminal can obtain the URL or the IP address by referring to the table in the recording medium.

The recording medium can be provided to the user at the time of selling the digital camera to the user, or at the time of the user's visit to the agency, or by distribution to the user on a street, for example.

The user who installed the program to his/her personal computer places the print order from the photograph processing agency from which the recording medium recorded with the program was obtained. In this manner, the photograph processing agency can attract the user.

The user may obtain similar recording media having the same program from a plurality of photograph processing agencies and may install the programs therein to his/her personal computer. In this case, the photograph processing agencies may be added one by one at respective installations so that the user can select the specific agency at the time of transferring the order information. In this manner, the choice of the agencies for placing the order from can be expanded. Alternatively, a specific agency may be overwritten at each installation so that only the agency corresponding to the program of the last installation can be accessed.

The recording media having the program for causing a computer to execute generation and transfer of the order information may be produced in a large quantity at a recording-media manufacturing plant and distributed to the photograph processing agencies. In this case, each of the photograph processing agencies has recording means (such as a CD-R drive) so that the access information used for accessing the order reception server thereof can be recorded in the recording media by the recording means.

In this manner, each of the agencies can induce the user to place the print order therefrom by simply recording the access information in the recording media. As a result, each of the agencies can easily increase the profits thereof.

The access information may be provided to the user by being recorded in a recording medium other than the recording medium having the aforementioned program recorded therein.

The access information can be provided to the user by being printed on a printing medium such as a leaflet, an advertisement, a coupon, or the back of a print generated by the specific agency, for example. The access information may also be provided to the user by being uploaded to a Web site of each of the agencies.

In the case where the access information is printed on a printing medium, the user may input the access information to the order terminal by using input means such as a mouse and a keyboard. Alternatively, the user may input the access information by reading the access information printed on the printing medium with a bar code reader or OCR means.

By using the access information printed on a leaflet or an advertisement, the user can place the order from the agency providing better service or charging less. Therefore, the user can receive better service. Meanwhile, each of the agencies can attract the user as a customer thereof by advertising themselves with the leaflet or the advertisement, and can increase the profits thereof.

In order to obtain the access information from the Web site, the user downloads to the order terminal the access information uploaded to the Web site of each of the agencies. By obtaining the access information from the Web site, the user can confirm via the Internet the content of services, a charge per print, and the time of delivery, for each of the agencies. In this manner, the user can select a desired agency. Meanwhile, each of the agencies can induce the user to place the order therefrom, by using advertisement in the Web site.

In the print order system of the present invention, it is preferable for the order terminal to obtain photograph processing agency information by accessing the order reception server of the specific photograph processing agency.

The “photograph processing agency information” refers to information specific to the agency, such as information on a name, a logo, an address, and a phone number of the agency, a map showing location of the agency, a menu representing the content of services provided (such as generation of picture postcards or a calendar), a charge per print, the time of delivery, business hours, days that the agency is closed, and an indication that the agency is closed if the day of access to the order reception server is a day that the agency is closed.

By obtaining the agency information with the order terminal, the user is informed of the charge or the time of delivery, for example. Based on the information, the user can cancel order placement from the specific agency he/she wanted to use, if the agency charges more than the other agencies or needs more time to provide the prints, for example.

In the print order system of the present invention, it is preferable for the order reception server of the specific photograph processing agency to notify the order terminal of status of printing based on the order information.

The “status of printing” refers to information indicating how the print order is being processed, such as whether printing based on the order information has been started or in progress or completed, for example.

The order reception server may notify the order terminal of the printing status either at the request of the order terminal or periodically without the request.

By notifying the order terminal of the printing status in this manner, the user can understand the printing status. Therefore, the user can avoid a situation where he/she visits the agency before completion of printing and has to wait for completion.

In the print order system of the present invention, it is preferable for the photograph processing agencies to respectively install attachment information output means for printing attachment information attached to the prints, based on the order information.

The “attachment information” includes not only the name, the address, and the phone number of the user but also the content of the prints, charges therefor, and an ID number for identifying the order information, for example.

If the attachment information is printed and attached to a DP bag having the prints therein, the prints generated by the photographic printer can be classified easily and a bill to the user can be issued easily.

A printing system of the present invention is installed in a photograph processing agency and comprises:

a photographic printer for outputting a print of image data; and

an order reception server which can receive, via a network, order information generated by an order terminal used for placing an order for the print of the image data.

It is preferable for the printing system of the present invention to further comprise recording means for recording access information for accessing an order reception server installed in a specific photograph processing agency via the network, in a recording medium having a program recorded therein to cause the order terminal to execute generation and transfer of the order information.

In the printing system of the present invention, it is preferable for the order terminal to be notified of status of printing based on the order information.

Furthermore, it is preferable for the printing system of the present invention to further comprise attachment information output means for outputting attachment information to be attached to the print, based on the order information.

An order terminal of the present invention is installed in a photograph processing agency which has a photographic printer for outputting image data as a print. The order terminal is connected via a network to an order reception server which can receive order information regarding the image data, and the order terminal generates the order information. The order terminal places a print order regarding the image data by transferring the order information to an order reception server installed in a specific photograph processing agency after directly accessing the order reception server of the specific agency via the network.

In the order terminal of the present invention, it is preferable for the order information to be generated and transferred according to a program that causes a computer to execute the procedures of generating the order information and transferring the order information to the order reception server installed in the specific photograph processing agency via the network.

In this case, access information for accessing the order reception server in the specific photograph processing agency via the network is preferably recorded in a recording medium having the program recorded therein. In this manner, the order terminal can read the access information from the recording medium and can access the order reception server installed in the specific agency, based on the access information that has been read.

A program to execute the procedures of:

generating order information regarding image data; and

transferring the order information to an order reception server installed in a photograph processing agency by directly accessing the order reception server according to access information for directly accessing the order reception server may be provided.

In this case, it is preferable for the program to be recorded in a recording medium. In this case, it is also preferable for the recording medium to have the access information recorded therein.

According to the present invention, each of the agencies has the photographic printer and the order reception server which can receive the order information. Therefore, if the user places the print order by directly accessing the order reception server in the specific agency from the order terminal, the agency can immediately carry out printing. As a result, the time necessary for receiving the prints can be shortened compared to the case of placing the print order via a server in an order reception center. Especially, in the case where the specific agency is located close to the place of residence or employment of the user, the prints can be received shortly after placing the order. Therefore, the user can obtain the prints as if the printer in the agency were owned by the user.

Furthermore, since the order terminal directly accesses the order reception server in the specific agency, the user can place the print order from the agency he/she wishes to use, without a troublesome operation therefor. In this manner, the print order can be placed easily. Meanwhile, each of the agencies can induce the user to place the order therefrom by making an effort therefor. Therefore, the profits thereof can be increased.

### BRIEF DESCRIPTION OF THE DRAWINGS

FIG. 1 is a block diagram showing a configuration of a first embodiment of a print order system of the present invention;

FIG. 2 is a flow chart showing a procedure carried out in the first embodiment;

FIG. 3 shows an overall image display screen;

FIG. 4 shows a setting screen;

FIG. 5 shows a confirmation screen;

FIG. 6 shows another setting screen;

FIG. 7 is a block diagram showing a configuration of a second embodiment of the print order system of the present invention;

FIG. 8 shows an overall image display screen in the second embodiment;

FIG. 9 shows a picture postcard generation screen;

FIG. 10 is a block diagram showing a configuration of a third embodiment of the print order system of the present invention;

FIG. 11 is a block diagram showing a configuration of a fourth embodiment of the print order system of the present invention;

FIG. 12 is a block diagram showing a configuration of a fifth embodiment of the print order system of the present invention;

FIG. 13 is a block diagram showing a configuration of a sixth embodiment of the print order system of the present invention and

FIG. 14 is a block diagram showing a configuration of a seventh embodiment of the print order system of the present invention.

### DESCRIPTION OF THE PREFERRED EMBODIMENTS

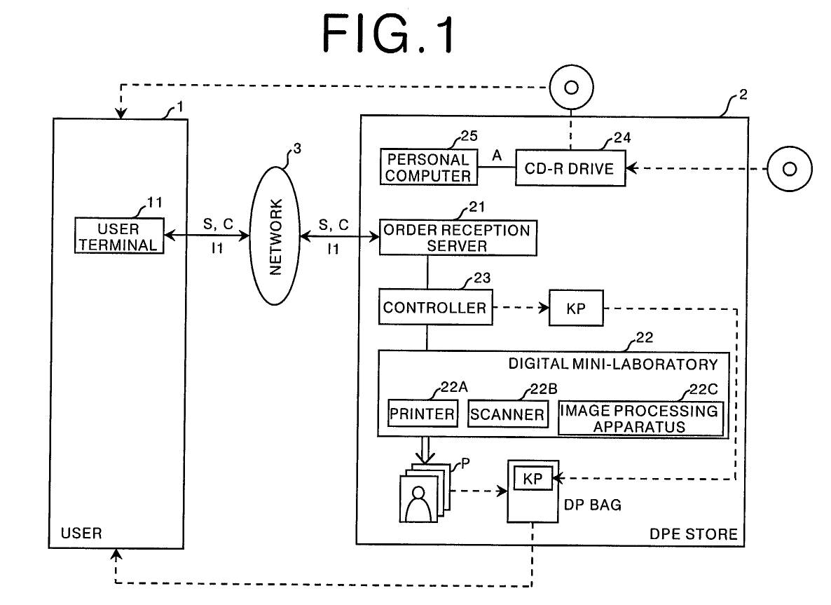

Hereinafter, embodiments of the present invention will be explained with reference to the accompanying drawings. FIG. 1 is a block diagram showing a configuration of a first embodiment of a print order system of the present invention. In this embodiment, the print order system exchanges data and prints between a user 1 and one of DPE stores 2 (referred to as a DPE store A), as shown in FIG. 1. In FIG. 1, a flow of data is shown by solid lines while a flow of prints is shown by dashed lines.

The user 1 has a personal computer as a user terminal 11 comprising a hard disc, a display, a keyboard, a mouse, a CD-ROM drive, and a PC card slot or the like for reading image data from a recording medium for a digital camera (such as SmartMedia and CompactFlash (registered trade mark)), for example. As will be explained later, the user terminal 11 can place a print order from the DPE store A via a network 3 such as the Internet. In the case where the user 1 does not posses a personal computer, the user 1 places a print order by using a terminal dedicated to placing orders and installed at a service provider or the like.

The DPE store A has an order reception server 21 for receiving the print order, a digital mini-laboratory 22 for obtaining a print or prints P (hereinafter referred to as the prints P) based on a set or sets of image data S (hereinafter, referred to as the image data sets S) transferred from the user terminal 11 via the network 3 at the time of placing the order, a controller 23 for controlling the order reception server 21 and the digital mini-laboratory 22, and a personal computer 25 having a CD-R drive 24 connected thereto for recording information in a CD-R.

The order reception server 21 has a function of transferring DPE store information I1 to the user terminal 11 for showing a menu representing the content of services provided by the DPE store A (that is, generation of ordinary prints and special prints such as picture postcards, and printing on a T-shirt or on a mug cup, for example), a charge per print, and the time of delivery, at the request or without request of the user terminal 11 when the user 1 accesses the order reception server 21. The order reception server 21 also has a function of storing order information C transferred from the user terminal 11, and is always connected to the network 3.

The digital mini-laboratory 22 has a printer 22A for generating the prints P based on the image data sets S, a scanner 22B for scanning a negative film, and an image processing apparatus 22C for carrying out image processing on the image data sets S. The digital mini-laboratory 22 has a function of writing the image data sets S in a recording medium such as a CD-R.

The controller 23 has a computer and a printer, and manages and controls the order reception server 21 and the digital mini-laboratory 22. An operator in the DPE store A operates the controller 23, and the controller 23 generates a sheet KP on which the charge per print, a name of the user, the content of the prints, and an order reception ID corresponding to the order information C are printed. The sheet KP is attached to a DP bag containing the prints P. In this manner, the prints P can be easily classified and a bill to the user 1 can be easily issued.

The CD-R drive 24 is connected to the personal computer 25 and records access information A for accessing the order reception server 21 of the DPE store A in a CD-R having viewer software used for image display, generation and transfer of the order information C. As the access information A, an IP address or URL of the order reception server 21 is used. The CD-R is provided to the user 1 upon a sale of a digital camera to the user 1, upon a visit of the user 1 to the DPE store A, or by distribution to the user 1 on a street, for example.

The user 1 sets the CD-R in the CD-ROM drive (not shown) of the user terminal 11, and installs the viewer software recorded therein to the user terminal 11. At this time, the access information A recorded in the CD-R is taken in by the viewer software. In this manner, the user 1 can browse through and manipulate the image data sets S, can generate the order information C, and can place the order. At the time of placing the order, the user terminal 11 accesses the order reception server 21 in the DPE store A corresponding to the access information A by using the viewer software, and the order information C and the image data sets S to be printed are transferred to the order reception server 21.

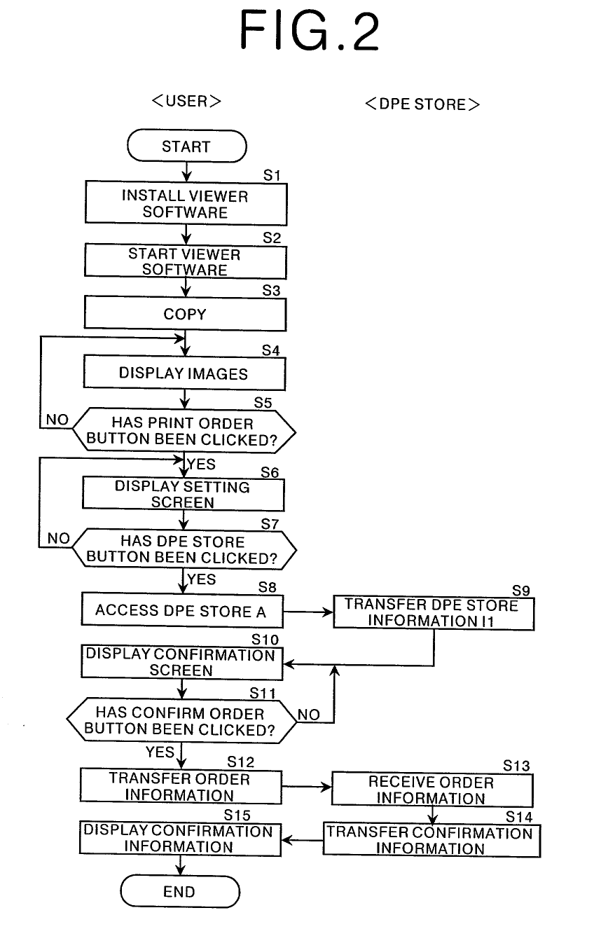

Operation of this embodiment will be explained next. FIG. 2 is a flow chart showing a procedure carried out in the first embodiment. The user 1 has the CD-R having the access information A of the DPE store A recorded therein. In this operation, the image data sets S owned by the user 1 are printed as ordinary prints (by the printer 22A of the digital mini-laboratory 22).

The user 1 installs the viewer software from the CD-R in the user terminal 11 (Step S1). At this time, the access information A is incorporated by the viewer software. The user 1 starts the viewer software (Step S2), and sets in the PC card slot the recording medium having the image data sets S recorded therein by the digital camera. By clicking a Copy button (not shown) of the viewer software, the image data sets S in the recording medium are copied in the hard disc of the user terminal 11 (Step S3). A folder for storing the image data sets S is automatically generated. When the user selects this folder and instructs overall image display, thumbnail images of the image data sets S are displayed (Step S4).

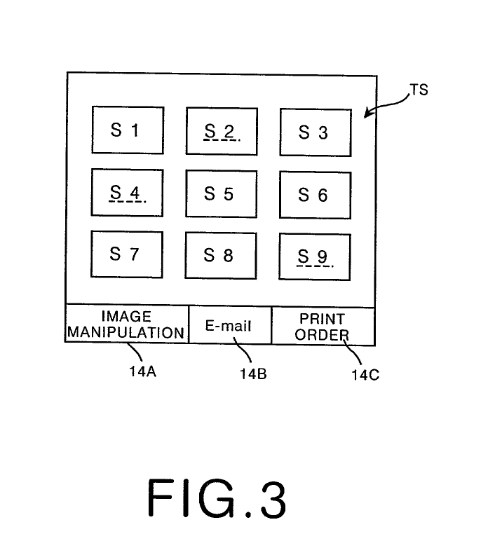

FIG. 3 shows an overall image display screen on the user terminal 11. As shown in FIG. 3, thumbnail images TS of the image data sets S stored in the folder, an Image Manipulation button 14A for manipulating an image or images (hereinafter, referred to as the images) represented by the image data sets S, an E-mail button 14B for attaching the images to an E-mail message, and a Print Order button 14C for placing the print order are shown in the screen. In FIG. 3, nine of the thumbnail images TS corresponding to the image data sets S (referred to as S1 to S9) are shown. However, by scrolling up and down, more of the thumbnail images TS can be shown. The Image Manipulation button 14A is used for carrying out trimming, brightness or color correction, or insertion of a caption on the images selected from the thumbnail images TS. By clicking the button 14A, the images represented by the selected image data sets S are manipulated.

The images to be printed (images S2, S4, and S9, for example) are then selected, and whether or not the Print Order button 14C has been clicked is judged (Step S5). If a result at Step S5 is affirmative, a setting screen for setting the content of printing is displayed (Step S6).

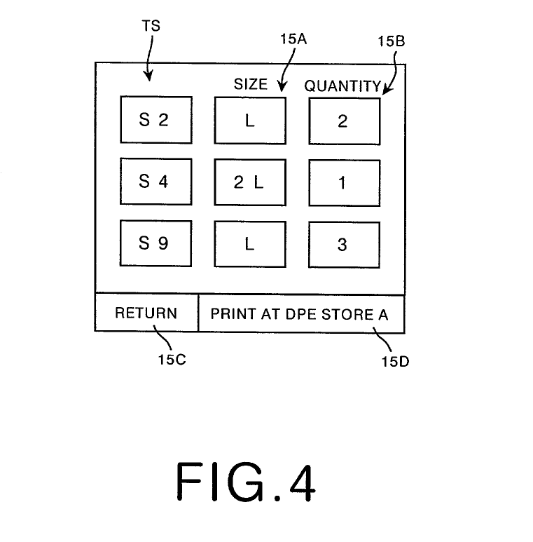

FIG. 4 shows the setting screen. As shown in FIG. 4, three of the thumbnail images TS corresponding to the images S2, S4, and S9 selected in the overall image display screen, print size input fields 15A, quantity input fields 15B, a Return button 15C for returning to the overall image display screen, and a DPE Store button 15D for accessing the DPE store A are shown in the setting screen.

Since the user 1 received from the DPE store A the CD-R having the viewer software and the access information A recorded therein and installed the viewer software from the CD-R to the user terminal 11, only the display “Print at DPE store A” is shown in the DPE Store button 15D so that only the DPE store A is used by the user 1 for printing.

In the setting screen, the user 1 inputs print sizes and quantities in the print size input fields 15A and the quantity input fields 15B for all the selected images. Since there are limited print sizes available, each of the print size input fields 15A may have a pull-down menu. The user 1 can select the images again in the overall image display screen by clicking the Return button 15C.

Whether or not the DPE Store button 15D has been clicked is then judged (Step S7). If a result at Step S7 is affirmative, the user terminal 11 accesses the order reception server 21 of the DPE store A by using the viewer software (Step S8). After the access, the order reception server 21 transfers the DPE store information I1 regarding the DPE store A to the user terminal 11 (Step S9). The DPE store information I1 may be transferred after the access, either automatically or by an instruction from the user terminal 11.

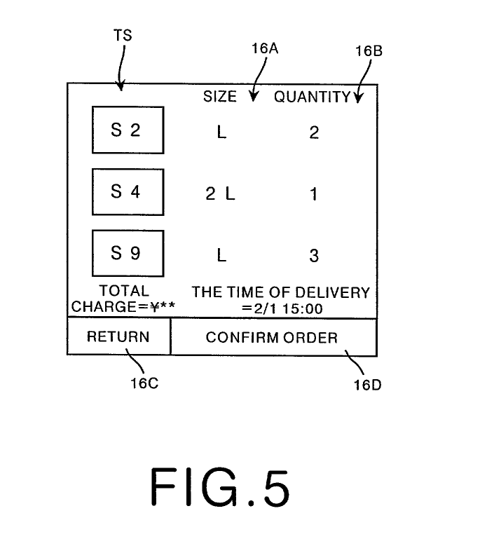

The user terminal 11 receives the DPE store information I1, and displays a confirmation screen. In the confirmation screen, a total charge corresponding to the print sizes, the quantities input by the user, and the time of delivery are shown, based on the DPE store information I1 (Step S10). FIG. 5 shows the confirmation screen. As shown in FIG. 5, the thumbnail images TS shown in the setting screen, fields 16A for displaying the confirmed sizes, fields 16B for displaying the confirmed quantities, Return button 16C for returning to the setting screen, and Confirm Order button 16D for confirming the order are displayed in the confirmation screen.

The user 1 can confirm the total charge and the time of delivery on the confirmation screen. If necessary, the user 1 can change the sizes or the quantities of the prints in the setting screen by clicking the Return button 16C.

Whether or not the Confirm Order button 16D has been clicked is then judged (Step S11). If a result at Step S11 is affirmative, the order information C describing the content of the order is transferred to the order reception server 21 of the DPE store A to carry out the printing, together with the image data sets S to be printed (Step S12). The order information C includes file names of the image data sets S to be printed, the sizes and the quantities of the prints, and information on the user 1 (such as the name, an address, and a phone number of the user 1). The order reception server 21 receives the order information C and the image data sets S (Step S13). The order reception server 21 then generates confirmation information indicating the order reception ID for identifying the order, the total charge, and the time of delivery, and transfers the confirmation information to the user terminal 11 (Step S14). The time of delivery refers to the time of delivery determined from the time of reception of the order information C by the order reception server 21. For example, if the order reception server 21 receives the order information C during business hours of the DPE store A, the time of delivery is determined to be three hours after the reception. In the case where the order information C is received outside the business hours, the time of delivery is the opening time on the following day. The confirmation information is displayed on the user terminal 11 (Step S15), and the procedure ends.

The controller 23 in the DPE store A regularly checks the reception of the order information C by the order reception server 21. In the case where the order information C has been received, an order reception sheet is printed and the operator is notified of the reception. The operator checks the reception of the order information Cat predetermined intervals determined by subtracting a processing time from three hours (for example, if the processing time is one hour, the reception is checked at every two hours) if the delivery is three hours after the reception, and generates the prints P by using the controller 23 based on the order information C transferred to the order reception server 21. In other words, the operator operates a start switch (not shown) in the controller 23 so that the order information C and the image data sets S are transferred from the order reception server 21 to the digital mini-laboratory 22. In this manner, the order information C and the image data sets S are transferred to the mini-laboratory 22. The image data sets S are printed from the printer 22A of the digital mini-laboratory 22 based on the order information C, and the prints P are generated. At this time, the order reception ID is printed on the back of the prints P, and the prints P are sorted according to order that the order information C was received. At the same time, the controller 23 prints the name of the user 1, the content of the prints P, the total charge, and the order reception ID on the sheet KP. The sheet KP is attached to the DP bag containing the prints P, and the prints P on which the corresponding order reception ID is printed are put in the DP bag. The user 1 visits the DPE store A after the time of delivery, and receives the prints P by paying the total charge. Alternatively, the prints P may be delivered to the user 1.

As has been described above, in the first embodiment of the present invention, the DPE store A has the printer 22A and the order reception server 21 for receiving the order information C. Therefore, if the user 1 directly accesses the order reception server 21 of the DPE store A from the user terminal 11 and places the order therefrom, the DPE store A can immediately carry out the printing. As a result, the time necessary for the user to receive the prints P can be shortened when compared to the case of placing the order via a server in an order reception center as in a conventional network photograph service system. Especially, if the order is placed from the DPE store A located close to the place of residence or employment of the user 1, the user 1 can receive the prints P immediately after completion of the printing. Therefore, the user 1 can use the printer 22A of the store A as if it were owned by the user.

Furthermore, since the user terminal 11 accesses the order reception server 21 of the DPE store A, the user 1 can place the order from the DPE store A desired by the user, without a troublesome operation therefor. In this manner, the order can be placed easily. Meanwhile, the DPE store A can induce the user to place the order therefrom by making an effort such as providing the CD-R to the user 1, and the DPE store A can increase the profits thereof.

Since the access information A of the DPE store A is recorded in the CD-R having the viewer software recorded therein, the access information A is taken in by the viewer software upon installation of the software to the user terminal 11. Therefore, if the DPE store A provides the CD-R to the user 1 for installation of the viewer software to the user terminal 11, the user terminal 11 automatically accesses the order reception server 21 of the DPE store A. In this manner, the DPE store A can attract the user 1 as a customer of the store.

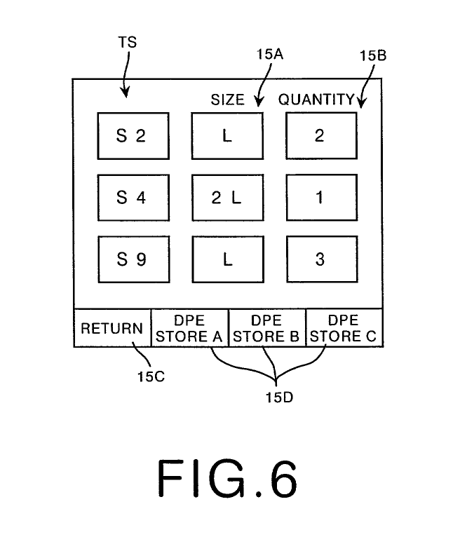

The user 1 may install the viewer software to the user terminal 11 by obtaining the software from the plurality of DPE stores 2. In this case, the DPE stores 2 are added by each installation to be displayed on the DPE Store button 15D of the setting screen shown in FIG. 4. In this manner, the user can select one of the DPE stores 2 as desired. At this time, as shown in FIG. 6, the user 1 selects the desired store from the DPE Store buttons 15D representing each of the stores, such as the DPE store A, a DPE store B, and a DPE store C, for example. In this manner, choice of the DPE stores 2 to place the order from can be expanded. Alternatively, only the DPE store 2 corresponding to the access information A recorded in the CD-R from which the viewer software was installed last time may be displayed in the screen.

If the plurality of stores 2 are selectable and if the user 1 obtains the DPE store information I1 for each of the DPE stores 2, the user 1 can compare the menu, the charge per print, and the time of delivery among all the stores. In this manner, the user 1 can select the desired DPE store 2 charging the least or finishing the printing fastest, for example.

In the above embodiment, the store information I1 is input to the user terminal 11 by accessing the order reception server 21 of the DPE store A. Therefore, before the access to the order reception server 21, the menu, the charge per print, and the time of delivery of the DPE store A from which the user wishes to place the order are not known. However, if the DPE store information I1 is stored in the user terminal 11, the menu, the charge, and the time of delivery can be displayed based on the DPE store information I1 by booting up the viewer software, without accessing the order reception server 21.

When the DPE store A records the access information A in the CD-R, the DPE store information I1 may be written as an initial setting. In this manner, the user 1 knows the DPE store information I1 of the DPE store A, without accessing the order reception server 21 thereof. Since the menu, the charge, and the time of delivery change frequently, it is preferable for the menu, the charge, and the time of delivery regarding the DPE store A to be updated by obtaining the latest DPE store information I1 at each access to the order reception server 21 of the DPE store.

In the above embodiment, the DPE store A has only the digital mini-laboratory 22. Therefore, only printing of the image data sets S can be carried out therein. For this reason, it is preferable for the DPE store A to collaborate with another store so that various kinds of services (such as picture postcard generation and printing on a T-shirt) can be provided. Hereinafter, a second embodiment of the print order system of the present invention in which the DPE store A collaborates with another store will be explained.

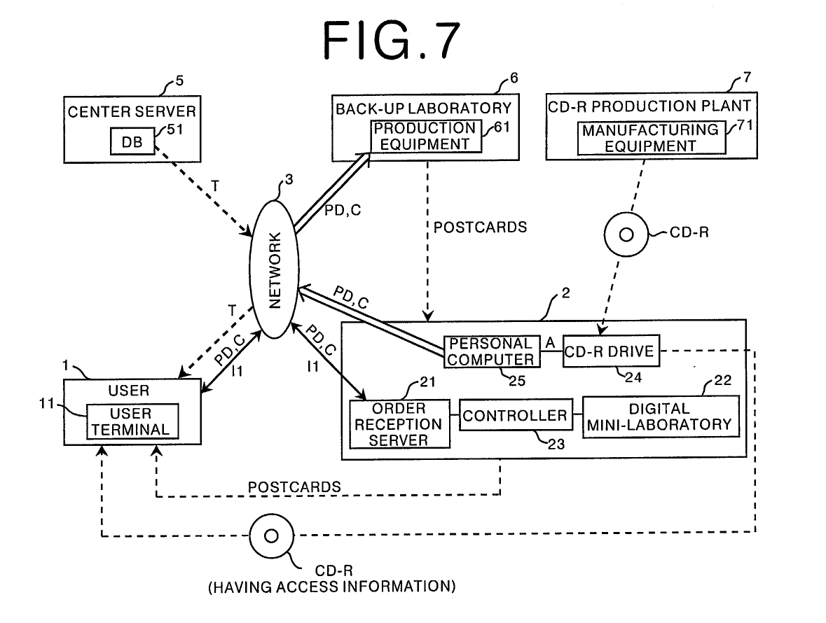

FIG. 7 is a block diagram showing a configuration of the second embodiment of the print order system of the present invention. As shown in FIG. 7, a back-up laboratory 6 and a CD-R production plant 7 are added as collaborators in the print order system of the second embodiment.

A center server 5 has a template database 51 (hereinafter referred to as the DB 51) storing templates T used for generating picture postcards. The DB 51 is connected to a user terminal 11 via a network 3. The templates T may be provided to a user 1 by being recorded in a CD-R or the like. However, picture postcards are seasonal and tend to be influenced by the fashion. Therefore, the templates T of the latest design are in great demand. Consequently, the latest templates T are stored and managed in the DB 51 of the center server 5 to meet the demand of the user 1.

The back-up laboratory 6 has production equipment 61 for producing picture postcards or T-shirts with prints thereon, for example. The production equipment 61 has a server (not shown) and connected to an order reception server 21 via the network 3.

The CD-R production plant 7 has manufacturing equipment 71 for producing CD-Rs having viewer software recorded therein. The CD-Rs produced here are provided to DPE stores 2.

As will be explained later, a personal computer 25 is connected to the network 3 in each of the DPE stores 2 in order to transfer data of the order reception server 21 to the production equipment 61 of the back-up laboratory 6.

Operation of the second embodiment will be explained next. In the CD-R production plant 7, the CD-Rs having the viewer software recorded therein for generating a picture postcard or the like are produced by using the manufacturing equipment 71, and provided to the DPE stores 2. Each of the DPE stores 2 records in the CD-Rs access information A of the store for accessing the order reception server 21 of the store, by using a CD-R drive 24. ACD-R having the access information A recorded therein is provided to the user 1. The user 1 installs the viewer software to the user terminal 11 as in the first embodiment, and places a print order regarding image data sets S.

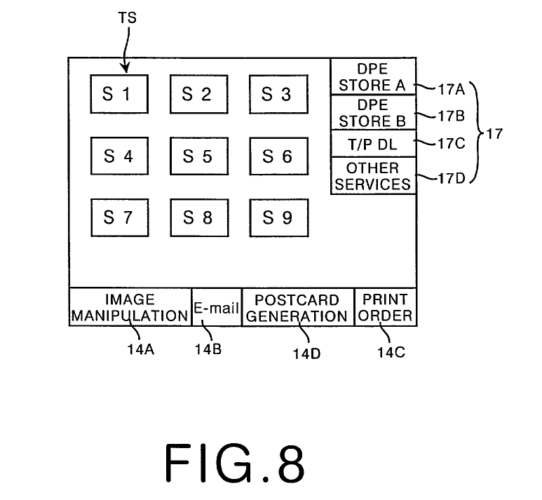

FIG. 8 shows an overall image display screen displayed on the user terminal 11 in the second embodiment. As shown in FIG. 8, thumbnail images TS, an Image Manipulation button 14A, an E-mail button 14B, and a Print Order button 14C are displayed in the overall image display screen, as in the first embodiment. Furthermore, a Postcard Generation button 14D for generating a picture postcard, and a Connection button 17 for connecting to a network service are also shown in the screen. The Connection button 17 comprises DPE Store buttons 17A and 17B, a T/PDL button 17C for accessing the DB 51 of the center server 5 for downloading the templates T, and an Other Services button 17D for accessing the collaborators for services other than the services displayed in the screen (such as printing on a T-shirt).

In the case where the user 1 places an order for picture postcard generation, the templates are necessary therefor. Consequently, the user 1 clicks the T/PDL button 17C in the overall image display screen, and accesses the DB 51 of the center server 5. In this manner, the user 1 downloads any one of the templates T as desired. The number of the templates T to be downloaded may be one or more. The user 1 then selects one of the image data sets S to be printed and clicks the Postcard Generation button 14D. In this manner, postcard data PD representing a composite image based on the template T and the image data set S that have been selected are generated.

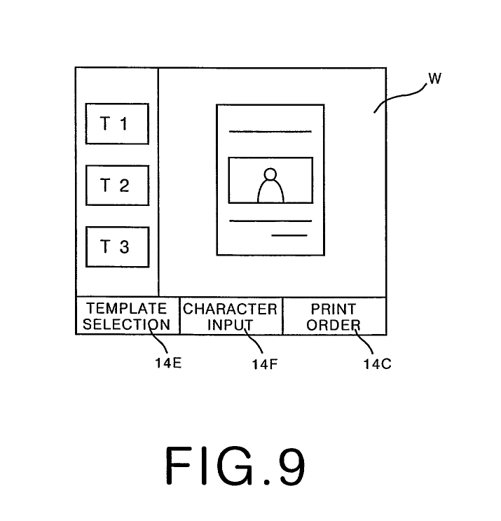

FIG. 9 shows a picture postcard generation screen shown on the user terminal 11. As shown in FIG. 9, thumbnail images of the templates T that have been downloaded (templates T1 to T3 in this example), a composite image window W, a Template Selection button 14E for selecting a desired one of the templates T, a Character Input button 14F for inputting characters in the composite image window W, and a Print Order button 14C are displayed in the screen. By selecting the desired template and clicking the Template Selection button 14E, a composite image generated from the selected template T and the image data set S selected in the overall image display screen in FIG. 8 is shown in the composite image window W. By clicking the Character Input button 14E, a cursor is displayed in a predetermined position in the composite image displayed in the composite image window W to enable an input of characters. By dragging or dropping the image in composition with the template T in the composite image window W, the position of the image can be adjusted. By clicking the Print Order button 14C after completion of composite image generation, the order can be placed as in the first embodiment. At this time, a charge for picture postcard generation and the time of delivery are shown on the user terminal 11.

Since the DPE stores 2 do not have the production equipment for picture postcard generation, the order reception server 21 of the DPE store 2 that has received the postcard data PD and order information C transfers the data and the information to the server in the production equipment 61 of the back-up laboratory 6, via the personal computer 25. The data and the information are transferred in the same manner as the transfer from the user terminal 11 to the order reception server 21. The postcard data PD and the order information C may be recorded in a recording medium such as a magneto-optical disc and directly provided to the back-up laboratory 6. In the back-up laboratory 6, the picture postcard or the picture postcards (hereinafter referred to as the postcards) are generated by the production equipment 61 and provided to the DPE store 2. The user 1 visits the DPE store 2 after the time of delivery displayed on the user terminal 11 at the time of placing the order, and receives the postcards after paying the charge. In the back-up laboratory 6, a sheet KP is printed based on the order information C, as in the first embodiment, and the user 1 is invoiced via the DPE store 2 based on the content of the sheet KP.

In the overall image display screen shown in FIG. 8, “store A” and “store B” are shown in the DPE Store buttons 17A and 17B, since the user 1 installed the viewer software from the CD-Rs provided by the DPE stores A and B to the user terminal 11. Therefore, by clicking the DPE Store button 17A indicating the DPE store A, the user terminal 11 can access the order reception server 21 of the DPE store A. Likewise, the user terminal 11 can access the order reception server 21 of the DPE store B by clicking the DPE Store button 17B indicating the DPE store B. The user 1 can also download DPE store information I1 from the order reception server of each of the DPE stores 2 to the user terminal 11.

By clicking the Other Services button 17D, the user can access the collaborators which can generate the T-shirts with the prints.

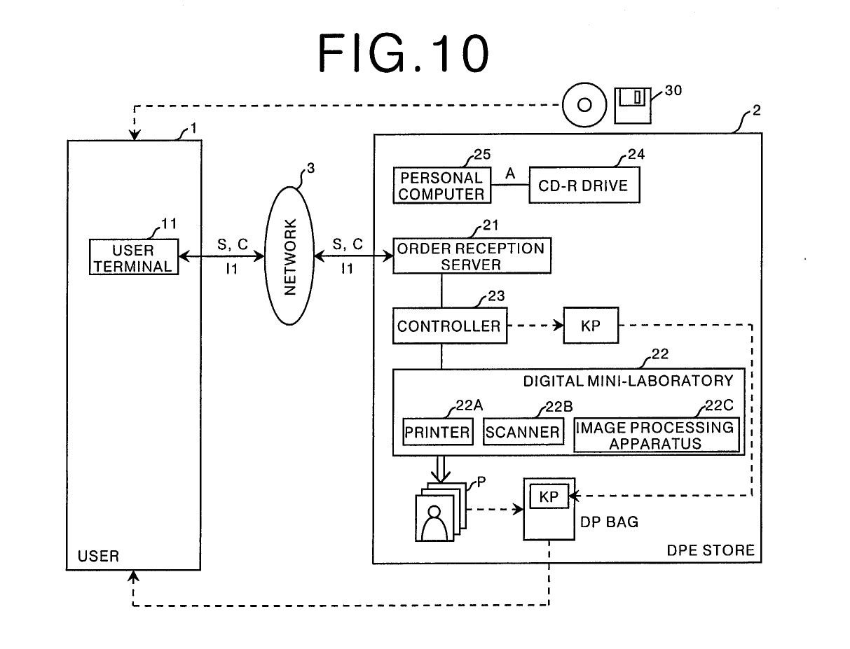

In the above embodiment, the access information A of each of the DPE stores 2 is recorded in CD-Rs having the viewer software recorded therein. However, in a third embodiment of the print order system of the present invention shown in FIG. 10, viewer software is recorded in a CD-ROM while access information A is recorded in a recording medium 30 such as an floppy disc separate from the CD-ROM, and provided to a user 1. Since CD-ROMs can be produced in large quantity by pressing, the viewer software can be provided at lower cost than in the case of providing the viewer software recorded in a CD-R. In this case, the user 1 installs the viewer software and reads the access information A from the recording medium 30. The user stores the access information A in a user terminal 11 and inputs the access information A to the viewer software at the time of starting the viewer software.

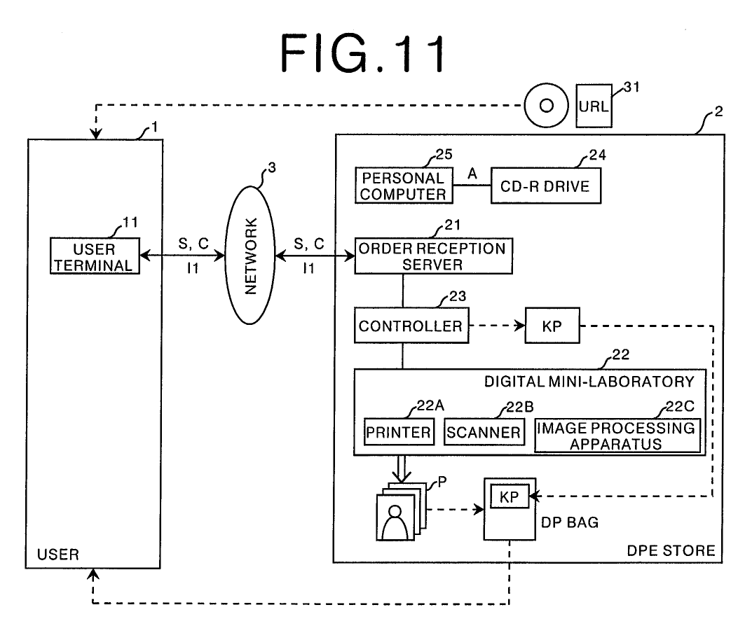

Furthermore, in a fourth embodiment of the print order system of the present invention shown in FIG. 11, each of the DPE stores 2 can provide to a user 1 a printing medium 31 such as a leaflet or an advertisement on which access information A (the IP address or URL) of the DPE store 2 for accessing an order reception server 21 thereof is printed. After the user 1 installs viewer software, the user inputs the access information A printed on the printing medium 31 to a user terminal 11. The access information A may be input manually by using a keyboard. Alternatively, the access information A may be input to the user terminal 11 by being read from the printing medium with OCR means. In this manner, the user 1 can access any one of the DPE stores 2 providing a better service by comparing the advertisement or the like.

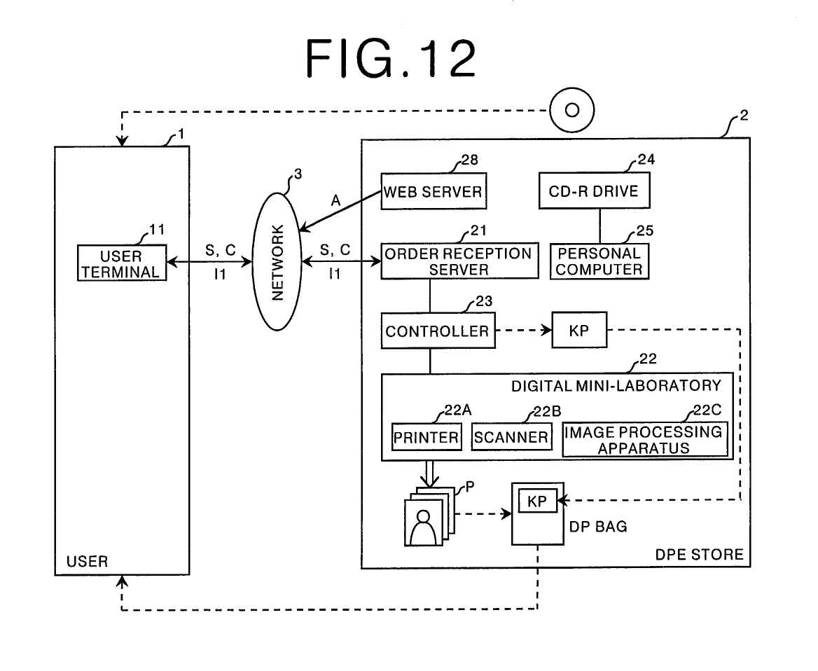

In a fifth embodiment of the print order system of the present invention shown in FIG. 12, each of DPE stores 2 has a Web server 28. A user 1 accesses the Web server 28 and obtains access information A. In other words, each of the DPE stores 2 has a Web site of its own, and the user 1 accesses the Web server 28 thereof from a user terminal 11 via a network 3. In this manner, the user 1 can browse through the Web site. In the Web site, an advertisement indicating a charge per print, the content of services provided, and button for downloading the access information A of the DPE store 2 are shown. The user 1 accesses the Web server 28 of any one of the DPE stores 2 and selects a desired one of the DPE stores 2. By downloading the access information A of the selected DPE store, the user 1 can obtain the access information A. In this manner, the user 1 can access the DPE store 2 providing a better service by comparing the advertisements in the Web sites.

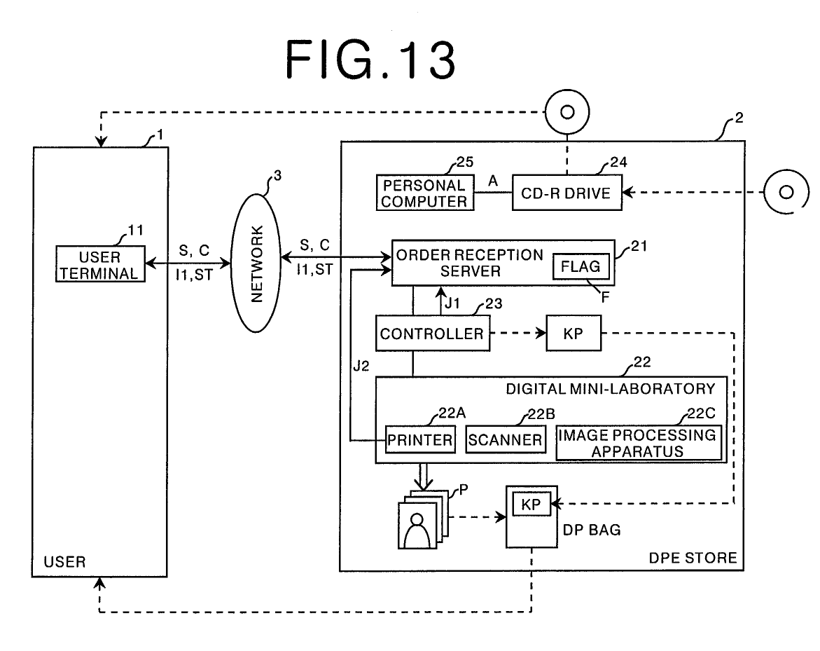

In a sixth embodiment of the print order system of the present invention shown in FIG. 13, an order processing status flag (hereinafter simply referred to as the flag) F representing progress of printing such as before printing, printing in progress, and printing completed may be used by an order reception server 21. A user 1 accesses the order reception server 21 from a user terminal 11, and confirms the progress of printing based on order information C. In other words, before image data sets S and the order information C are transferred to a digital mini-laboratory 22, the flag F is set to “before printing”. When an operator operates a start switch of a controller 23, information J1 indicating the start is input to the order reception server 21, and the flag F is set to “printing in progress”. After completion of printing, information J2 indicating the completion is input from a printer 22A of the digital mini-laboratory 22 to the order reception server 21, and the flag F is set to “printing completed”.

Viewer software installed in the user terminal 11 has a function of confirming the printing status, and Order Processing Status Confirmation button is displayed in an overall image display screen similar to the screen shown in FIG. 3, for example. The order reception server 21 checks the status of the flag F upon the access from the user terminal 11, and transfers status information ST representing the printing status to the user terminal 11. The user terminal 11 displays the printing status (such as before printing, or printing in progress, or printing completed) based on the status information ST. The order reception server 21 may check the flag F and transfer the status information ST to the user terminal 11 without a request of the user terminal 11.

In this manner, the user 1 understands how the order is being processed, and can avoid a situation of waiting for completion of printing at the DPE store 2.

In the above embodiments, the IP address or the URL is used as the access information A. However, the phone number, zip code, address or the like (hereinafter referred to as the phone number or the like) of each of the DPE stores 2 may be used as the access information A. In this case, each of the DPE stores 2 records the phone number or the like as the access information A in the CD-R by using the CD-R drive 24.

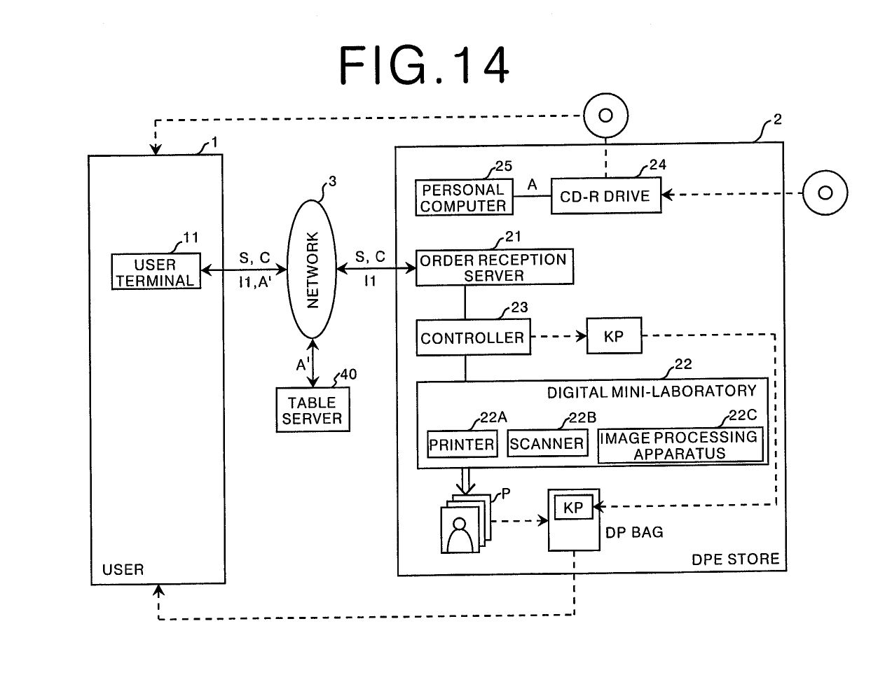

If the phone number or the like is used as the access information A, the order reception server 21 of the corresponding DPE store 2 cannot be accessed by directly using the access information A. In this case, as shown by a seventh embodiment of the present invention in FIG. 14, a table server 40 storing a table relating a phone number or the like to access information A′ comprising an IP address or URL of an order reception server 21 is installed. A user terminal 11 accesses the table server 40 via a network 3, and refers to the table stored in the table server 40. In this manner, the access information A′ comprising the IP address or the URL can be obtained based on access information A comprising the phone number or the like.

The table stored in the table server 40 may be recorded in a CD-R and provided to a user 1 so that the user 1 can obtain the access information A′ comprising the IP address or the URL while referring to the table recorded in the CD-R by using the user terminal 11.

In the case where the table is recorded in the CD-R and provided to the user 1, the access information A′ enabling an access to a DPE store 2 cannot be obtained in the case where the DPE store 2 has moved to another location or has changed the phone number thereof. For this reason, the table server 40 storing an updated table may be installed so that the access information A′ can be obtained by accessing the table server 40 if the access information A′ cannot be obtained by using the CD-R. Furthermore, the access information A′ may be obtained for another order reception server 21 in another DPE store 2 located close to the DPE store 2 having the order reception server 21 corresponding to the access information A, by referring to the table recorded in the CD-R based on the access information A comprising the phone number or the like.

In the above embodiments, the order for generating the prints P is placed at the DPE store 2. However, the print order system of the present invention is applicable to any photograph processing agency such as a laboratory dedicated to printing and not having a storefront, for example.

What is claimed is:

1. A print order system comprising:
order reception servers enabling reception of order information regarding image data via a network and installed respectively in a plurality of photograph processing agencies each having a photographic printer for printing the image data; and
an order terminal connected to the order reception servers via the network, the order terminal generating the order information and placing an order for a print of the image data by transferring the order information to a corresponding one of the order reception servers installed in a specific one of the photograph processing agencies after directly accessing the order reception server of the specific photograph processing agency.

2. A print order system as defined in claim 1, wherein the order information is generated and transferred by a program installed in the order terminal, the program causing a computer to execute the procedures of generating the order information and transferring the order information to the order reception server installed in the specific photograph processing agency.

3. A print order system as defined in claim 2, wherein the program is recorded in a recording medium, the recording medium further recorded with access information used for accessing the order reception server of the specific photograph processing agency, and the order terminal reads the access information from the recording medium and accesses the order reception server of the specific photograph processing agency based on the access information that has been read.

4. A print order system as defined in claim 3, wherein the photograph processing agencies respectively have recording means for recording the access information in the recording medium having the program recorded therein.

5. A print order system as defined in claim 1 or 2, wherein the access information used for accessing the order reception server of the specific photograph processing agency is recorded in a recording medium, and
the order terminal reads the access information from the recording medium and accesses the order reception server of the specific photograph processing agency based on the access information that has been read.

6. A print order system as defined in claim 1 or 2, wherein access information used for accessing the order reception server of the specific photograph processing agency is printed on a printing medium, and
the order terminal reads the access information from the printing medium and accesses the order reception server of the specific photograph processing agency based on the access information that has been read.

7. A print order system as defined in claim 1 or 2, wherein access information used for accessing the order reception server of the specific photograph processing agency is obtained from a predetermined Web server, and
the order terminal accesses the order reception server of the specific photograph processing agency based on the access information that has been obtained.

8. A print order system as defined in claim 1 or 2, wherein access information used for accessing the order reception server of the specific photograph processing agency is input to the order terminal, and
the order terminal accesses the order reception server of the specific photograph processing agency based on the access information that has been input thereto.

9. A print order system as defined in claim 1, wherein the order terminal accesses the order reception server of the specific photograph processing agency and obtains photograph processing agency information regarding the specific photograph processing agency.

10. A print order system as defined in claim 9, wherein the photograph processing agency information includes a charge of the print and the time of delivery of the print.

11. A print order system as defined in claim 1, wherein the order reception server notifies the order terminal of status of printing based on the order information.

12. A print order system as defined in claim 1, wherein the photograph processing agencies respectively have attachment information output means for printing attachment information to be attached to the print, based on the order information.

13. A printing system installed in a photograph processing agency, the printing system comprising:
a photographic printer for outputting a print of image data; and
an order reception server enabling reception of order information via a network, the order information being generated by an order terminal used for placing an order for the print of the image data.

14. A printing system as defined in claim 13, further comprising recording means for recording, in a recording medium, access information used for accessing an order reception server installed in a specific photograph processing agency, the recording medium having a program recorded therein to cause the order terminal to execute generation and transfer of the order information.

15. A printing system as defined in claim 13 or 14, further comprising attachment information output means for outputting attachment information to be attached to the print, based on the order information.

16. A printing system as defined in claim 13, wherein the order terminal is notified of status of printing based on the order information.

17. An order terminal installed in a photograph processing agency, the photograph processing agency having a photographic printer for outputting image data as a print, the order terminal being connected via a network to an order reception server, the order reception server enabling reception of order information regarding the image data, and the order terminal generating the order information and placing a print order regarding the image data by transferring the order information to an order reception server installed in a specific photograph processing agency after directly accessing the order reception server of the specific photograph processing agency.

18. An order terminal as defined in claim 17, wherein the order information is generated and transferred according to a program, the program causing a computer to execute the procedures of generating the order information and transferring the order information to an order reception server installed in a specific photograph processing agency.

19. An order terminal as defined in claim 18, the program being recorded in a recording medium, the recording medium further recorded with access information used for accessing the order reception server in the specific photograph processing agency, and the order terminal reading the access information from the recording medium and accessing the order reception server installed in the specific photograph processing agency based on the access information that has been read.

20. A program causing a computer to execute the procedures of:
generating order information regarding image data; and
transferring the order information to an order reception server installed in a specific photograph processing agency by directly accessing the order reception server according to access information for directly accessing the order reception server.

21. A computer-readable recording medium recorded with the program defined in claim 20 and access information for directly accessing an order reception server installed in a photograph processing agency.
